(19) United States
(12) Patent Application Publication
(10) Pub. No.: US 2004/0042409 A1
(43) Pub. Date: Mar. 4, 2004

(54) Method for defining the coding for useful information generated according to different coding laws between at least two subscriber terminals

(76) Inventors: Klaus Hoffmann, Munchen (DE); Sven Sabrowski, Munchen (DE); Jean-Marie Stupka, Germering (DE)

Correspondence Address: MORRISON & FOERSTER LLP, 1650 TYSONS BOULEVARD, SUITE 300, MCLEAN, VA, 22102, US

(21) Appl. No.: 10/221,268

(22) PCT Filed: Jan. 29, 2002
(86) PCT No.: PCT/DE02/00310

(30) Foreign Application Priority Data
Feb. 13, 2001 (DE) 101 06 583.3
Aug. 28, 2001 (DE) 101 42 012.9

(51) Int. Cl. H04L 12/56

(52) U.S. Cl. 370/252; 370/395.1

(57) ABSTRACT

If TDM connections are typically switched through from origination TDM network to a target TDM network by way of a data network as the backbone (ATM or IP) (e.g. VoIP). The transitions between the TDM network and the data network go through media gateways. In pure TDM connections, the coding laws of the A side and the B side are identical. In TDM networks, there is coding according to “A-Law” (PCM30 networks) and “μ-Law” (PCM24 networks). In the transition from an A-Law network to a μ-Law network, the coding law has to be changed. In the “TDM” world, the conversion rule is that at the transition the μ-Law side converts to the A-Law. In the ATM and IP transmission networks now being formed, this is no longer a requirement. Therefore the invention establishes that transcoding can take place in both network types by carrying out this transcoding in the target network. In this connection, the result of the codec negotiation procedure (if it is used) is taken into consideration; i.e., transcoding takes place only if the G.711 codec is selected.

### CLAIM FOR PRIORITY

This application claims priority to International Application No. PCT/DE02/00310 which was published in the German language on Jun. 20, 2002.

### TECHNICAL FIELD OF THE INVENTION

The invention relates to a method for establishing coding for working data generated according to different coding laws, between at least two subscriber terminals.

### BACKGROUND OF THE INVENTION

Recent communications architectures provide for the separation of switching technology networks into units that are related to connection services (call feature servers) and the transport of working data (bearer control). In this connection, the transmission of working data can be carried out by means of different transport technologies at high bit rates, such as ATM, IP or Frame Relay.

With such separation, the telecommunications services presently being provided in narrow-band networks can also be implemented in broadband networks. In this method, subscribers are connected either directly (e.g., via a DSS1 protocol) or by way of switching centers structured as call feature servers (CFS) (e.g., via the ISUP protocol). The working data is converted into each transport technology being used via media gateways (MG).

Control of the media gateways is carried out by each assigned media gateway controller, and these controllers can be structured as call feature servers. To control the media gateways, the call feature servers use standardized protocols, such as the MGCP protocol or the H.248 protocol, for example. For communication among one another, the call feature servers use a standardized BICC (Bearer Independent Call Control) that represents a further development of an ISUP protocol.

The Q.765.5 BAT (bearer application transport) ITU-T standard protocol is used in the BICC protocol, and it also describes bearer RTP as the bearer technology for IP. Resource problems in the network that are solved using data compression are handled using this protocol. An optional CODEC negotiation procedure is currently provided for this purpose.

Instructions as to how this protocol is to be used are provided by another BICC protocol, the Q.1902.x BICC CS2 protocol (bearer independent call control capability set 2, with a separate service indicator in the MTP (message transfer part)), which is being developed as an ITU-T standard.

The working data that until now has been transmitted between two PSTN networks, for example, is transmitted over an ATM network or an IP network using this protocol. In this connection, a separation between signaling data and working data is completed for the transmission by means of the ATM or IP network. It is now a problem, in this regard, that the Q.1902.x BICC CS2 ITU-T standard does not take into account the problem of when a subscriber in an A-Law country wishes to establish a connection with a subscriber located in a μ-Law country. Since, in this case, the data being exchanged between the different subscribers is generated according to different coding laws, there is the risk that the working data will be corrupted. This problem is of particular concern in the case of telephone traffic, and telephone and data traffic, that crosses national borders (e.g., Europe (A-Law)—USA (μ-Law)). This problem does not exist with the analog connections that have been used until now, since it had been established in the previous TDM networks, through ITU-T Recommendation G.711, that transcoding from μ-Law to A-Law must be carried out in μ-Law networks.

### SUMMARY OF THE INVENTION

The invention indicates a way in which working data generated according to different coding laws can be exchanged in a packet-oriented manner.

In one embodiment of the invention, transcoding can take place in both network types. In this connection, transcoding is supposed to be carried out in the target network. Efficient coding and decoding is achieved in that a new indicator and an additional logic are introduced in the Q.765.5 BAT protocol, with which the origination network informs the target network which coding (A-Law or μ-Law) is to be used, taking into account the codec that was negotiated in the existing codec negotiation procedure that might have been used. If the codec G.711 is chosen in the codec negotiation, the target network then carries out the transcoding in accordance with the information in the new indicator, according to A-Law or μ-Law.

### BRIEF DESCRIPTION OF THE DRAWINGS

The invention is explained in detail below, on the basis of the exemplary embodiments shown in the drawings.

FIG. 1 shows a network configuration connecting to the invention.

### DETAILED DESCRIPTION OF THE INVENTION

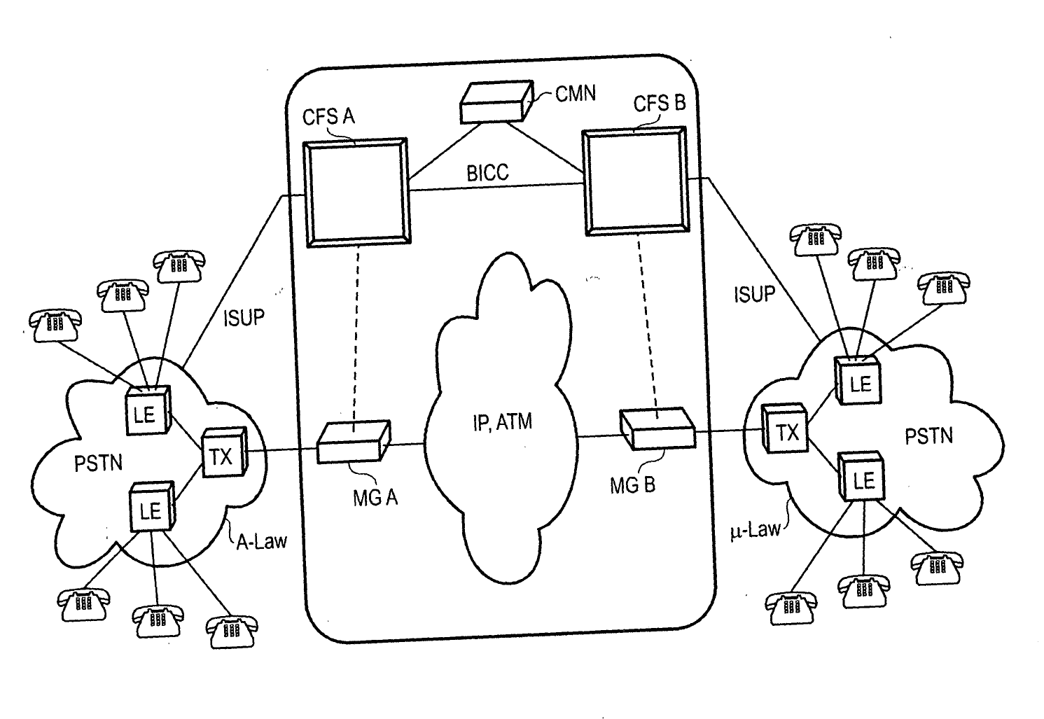

FIG. 1 shows a network configuration in which the method according to the invention is carried out. Two PSTN networks are shown, as an example, in each of which a plurality of subscribers is arranged in a known manner. These are passed to local switching centers LE, which in turn are connected with transit switching centers TX.

The separation between signaling data and working data is now carried out in the transit switching centers TX. The signaling data is passed by the transit switching center TX (ISUP protocol) directly to a media gateway controller CFS. The working data is passed to a media gateway MG A (arranged on the input side), which functions as an interface between the TDM network and an ATM or IP transmission network. The working data is transmitted over the ATM or IP network in a packet-oriented manner. The media gateway MG A is controlled by the media gateway controller CFS A, which is structured as a call feature server.

The working data is routed from the media gateway MG A to another media gateway MG B (arranged on the output side) by way of the ATM or IP network. There, the working data is converted back to a TDM data stream, under the control of the call feature server CFS B assigned to the media gateway MG B arranged on the output side, and passed to the subscriber in question.

The data transmitted between a call feature server and the respective media gateway assigned to it is supported by a standardized protocol. This can be the MGCP protocol or the H.248 protocol, for example. The Q.765.5 BAT protocol is provided as another standardized protocol between the two media gateway controllers CFS.

According to the invention, the A side (CFS A) informs the B side (CFS B) which coding (A-Law or μ-Law) is to be used when using a G.711 codec, by means of an A-Law or μ-Law indicator. The indicator is given to the B side in the BICC protocol, and evaluated there if the optional CODEC negotiation procedure is not being used.

If the optional CODEC negotiation procedure is used, the indicator is evaluated if the G.711 codec (A-Law or μ-Law) was selected simultaneous to the CODEC negotiation procedure of the Q.765.5 BAT protocol. If other codecs (such as G.723, for example) are selected by the CODEC negotiation procedure, the indicator has no significance.

If the A side is in an A-Law network, it indicates A-Law to the B side; if, in this case, the B side is in a μ-Law network, the B side converts from A-Law to μ-Law. If the A side is in a μ-Law network, it indicates μ-Law to the B side. If the B side is in an A-Law network, the B side converts from μ-Law to A-Law. If the networks of the A and B sides are using the same coding, no transcoding is carried out.

This is possible, since each media gateway has a direct interface to the TDM side. Therefore the coding is known on the TDM side of the media gateway. Alternatively, it is made known to the media gateway by the assigned call feature server MGC.

Both media gateways MG A and MG B can be adjusted in the appropriate manner by means of the MGCP (or H.248) protocol, using the information available to the call feature servers CFS A and CFS B that function as media gateway controllers.

1. Method for establishing the coding in the case of working data generated according to different coding laws, between at least two subscriber terminals, where an A side is defined according to the first coding law (A-Law) and a B side is defined according to the second coding law (μ-Law), the working data being transmitted by means of a plurality of transmission devices (MG A, MG B), which have the function of an interface between a first (TDM) and a second (ATM, IP) transmission network, and which are controlled by the respective control devices (CFS A, CFS B) assigned to them, which devices process the signaling data assigned to the working data, which they exchange by means of a signaling protocol, characterized in that
an indicator that is representative for the first coding law of the A side is provided, which is given to the B side, and by means of which the incoming working data is converted to the coding law of the B side, as determined by the evaluation that takes place on the B side.

2. The method according to claim 1, characterized in that
the indicator is only evaluated by the B side if the optional CODEC negotiation procedure is not used, or if it is used, if the G.711 codec (A-Law, μ-Law) was selected simultaneous to the CODEC negotiation procedure.

3. The method according to claims 1 and 2, characterized in that
conversion to the coding law of the receiving subscriber terminal only takes place if the A side and the B side generate working data according to different coding laws (A-Law, μ-Law).

4. The method according to claims 1 to 3, characterized in that
the first coding law is the A-Law coding law and/or the second coding law is the μ-Law coding law, or the first coding law is the μ-Law coding law and/or the second coding law is the A-Law coding law.

5. The method according to claims 1 to 4, characterized in that
if the A side is in an A-Law network and the B side is in a μ-Law network, only working data coded according to A-Law is offered to the B side, whereupon the B side converts from A-Law to μ-Law.

6. The method according to claims 1 to 4, characterized in that
if the A side is in a μ-Law network and the B side is in an A-Law network, only working data coded according to μ-Law is offered to the B side, whereupon the B side converts from μ-Law to A-Law.

7. The method according to one of the preceding claims, characterized in that
the transmission devices are structured as media gateways (MG A, MG B).

8. The method according to one of the preceding claims, characterized in that
the control devices (CFS A, CFS B) are structured as call feature servers.

9. The method according to one of the preceding claims, characterized in that
the exchange of the working data takes place at least partially in a packet-oriented manner.

10. The method according to one of the preceding claims, characterized in that
the packet-oriented transmission takes place according to an IP protocol, an ATM protocol or a Frame Relay protocol.

11. The method according to one of the preceding claims, characterized in that
the signaling protocol is a BICC protocol or an expanded ISUP protocol.
